(19) United States
(12) Patent Application Publication
(10) Pub. No.: US 2026/0280253 A1
(43) Pub. Date: Sep. 17, 2026

(54) INLINE MOUNTING/JUNCTION BOX FOR INVERTER USE WITH HIGHBAY FIXTURES

(71) Applicant: SIGNIFY HOLDING B.V., EINDHOVEN (NL)

(72) Inventor: ROBERT JOSEPH RIFFEL, BYHALIA, MS (US)

(21) Appl. No.: 19/168,941

(22) PCT Filed: Mar. 22, 2024
(86) PCT No.: PCT/EP2024/057764

§ 371 Date: Sep. 25, 2025

Related U.S. Application Data
(60) Provisional application No. 63/455,348, filed on Mar. 29, 2023.

(30) Foreign Application Priority Data
Sep. 22, 2023 (EP) 23199004.5

(51) Int. Cl. H02G 3/20; H02G 3/08

(52) U.S. Cl. CPC H02G 3/20; H02G 3/081

(57) ABSTRACT

A junction box is disclosed that permits inline mounting of an l electrical device, such as an inverter, to a highbay light fixture. The junction box of the present invention allows a standard inverter, meant to mount flat to a mounting surface, to be mounted inline on a chain or cable while providing an enclosed space for making wiring connections.

The invention relates generally to a device for use in adding functionality to a highbay lighting fixtures and in particular, to a device and method for positioning an inverter inline with the suspension means employed with the highbay lighting fixture.

### BACKGROUND

High bay luminaires are typically used in larger open indoor environments such as heavy industrial settings, warehouses, gyms, churches, and shopping malls. Conventional high bay lighting fixtures for commercial and industrial applications are often suspended by individual chains or cables from ceiling joists high above the floor.

Recently, lighting fixtures have begun using light emitting diodes (LEDs) as a light source. The use of LEDs and their reduced power requirements permits greater flexibility in adding features to the lighting system. In particular, individual LED light fixtures can be enabled as emergency light sources to provide light in the event of a power outage. This feature is obtained by incorporating an inverter with the light source. When AC power is available, the inverter provides DC power to the LED as well as maintains a charge in its internal battery. This battery is then available to provide power to the LED light fixture in the event AC power is interrupted.

### SUMMARY OF THE PRESENT INVENTION

According to an exemplary embodiment, a junction box is provided which is installed between a suspension chain, the upper end of which is anchored to the building structure, and a lighting fixture hanging from the bottom of the junction box. The junction box accessory of the current invention has knockout plugs that allow for connecting flexible conduit which allows for AC line voltage input, inverter inputs and outputs, and lighting fixture outputs. Moreover, this junction box allows a standard inverter, meant to mount flat to a mounting surface, to be mounted inline on a chain or cable while providing an enclosed space for making wiring connections.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIG. 1 illustrates the assembled junction box of the present invention;

FIG. 2 illustrates the junction box having been installed between the support chain and the light fixture;

FIGS. 3A and 3B illustrate components of an exemplary embodiment of the invention;

FIGS. 4A and 4B illustrate the action of the clamping flange when an inverter is attached to the junction box; and,

FIG. 5 illustrates components of the junction box in use connected to an inverter.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

In the following paragraphs, the present disclosure will be described in further detail by way of examples with reference to the attached drawings. In the description, well known components, methods, and/or processing techniques are omitted or briefly described so as not to obscure the disclosure. As used herein, the “present disclosure” and/or “present invention” refers to any one of the embodiments of the disclosure described herein and any equivalents. Furthermore, reference to various feature(s) of the “present disclosure” is not to suggest that all embodiments must include the referenced feature(s).

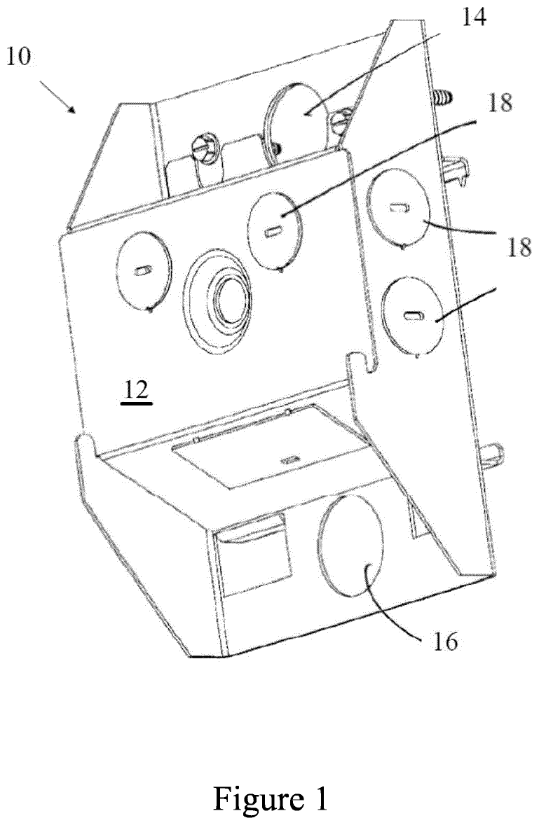

FIG. 1 illustrates the assembled junction box 10 of the present invention. The figure depicts a cover plate 12 in its attached position on the front of the junction box. As illustrated the assembled junction box 10 has an upper hole 14 which permits its attachment to a building structure (e.g., directly or by using a chain or cable). A bottom hole 16 is present for suspending a lighting fixture. Further, knockout plugs 18 are depicted that allow for connecting flexible conduit for AC line voltage input, inverter inputs, and lighting fixture outputs. Features related to the back of the junction box 10 will be discussed in detail below.

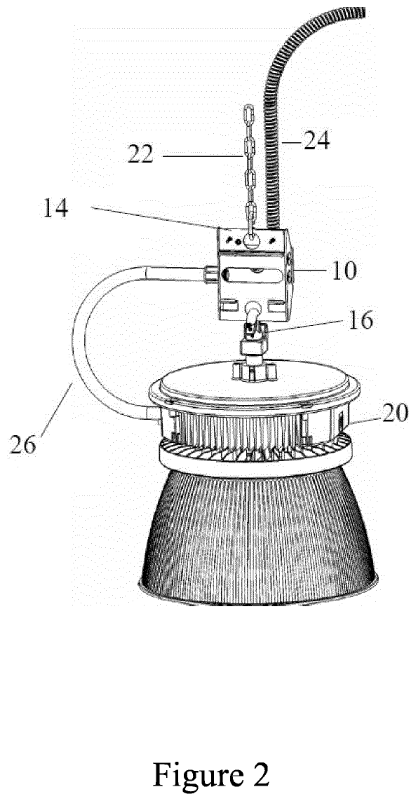

FIG. 2 illustrates the junction box 10 having been installed between the lighting fixture 20 and the chain 22 previously directly connected to the building structure for suspending the light fixture 20. That is, the chain 22 now connects to the upper hole 14 of the junction box 10; while the light fixture suspends from the bottom hole 16. Previously described knockout plugs enable AC line voltage to be supplied to the interior of the junction box 10 via cable 24 and electrical connections to the light fixture 20 to be supplied via flexible conduit 26.

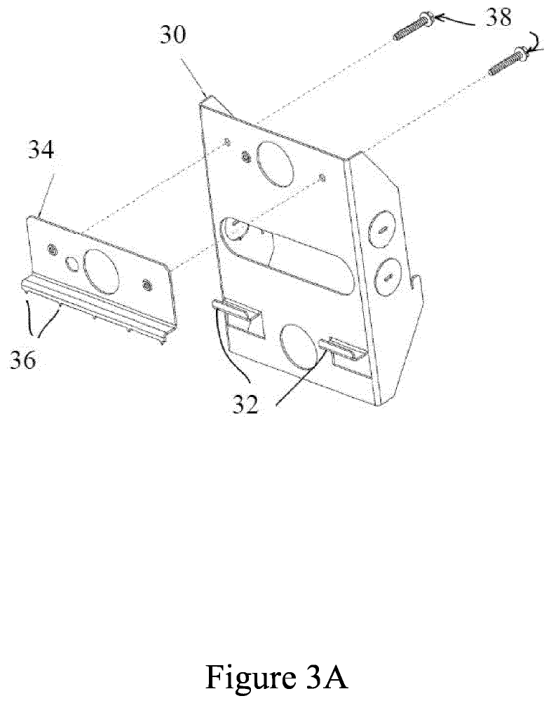

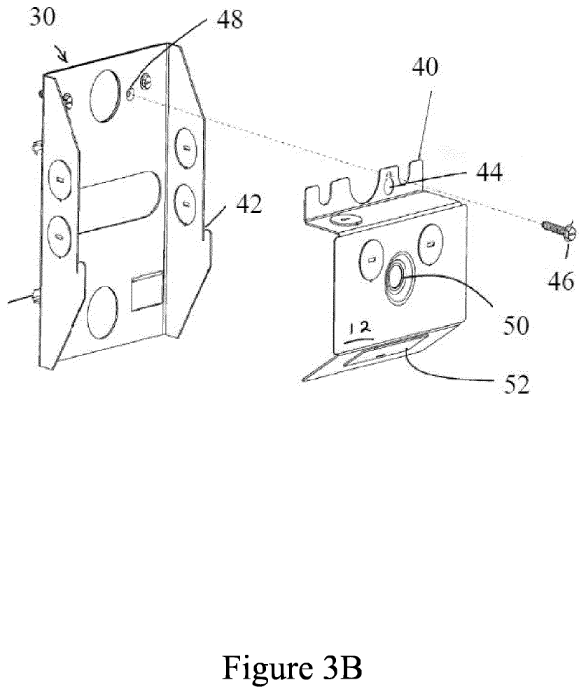

Individual components of the junction box will now be discussed with reference to FIGS. 3A and 3B. FIG. 3A illustrates a back view of the back section 30 of the junction box 10. This section contains support flanges 32 on the external side of the back section 30 for attaching an external device. The discussion below relates to that device being an inverter. However, the invention is not so limited as other types of external devices similar in size and shape to an inverter could be connected to the junction box. In the case of an inverter, the bottom edge of the inverter is positioned against the support flanges 32. A clamping flange 34 is then used to secure the inverter in place by tightening a plurality of clamping flange screws 38. In additional embodiments of the invention, the clamping flange comprises a series of V-shaped teeth 36 along its bottom edge to provide a more secure connection.

FIG. 3B illustrates a frontal view of back section 30 of the junction box 10. The figure further illustrates a front section 40 which when attached, functions as a cover 12 to form the junction box 10 when coupled together, to house the internal electrical connections. In the depicted embodiment, this securing occurs by attaching the lower end of the face of the front section 40 to tabs 42 on opposite sides of the back section 30, and then positioning a securing screw 46 through a hole 44 in the front section 40 and tightening it in a threaded hole 48 in the back section 30.

FIG. 3B further illustrates an access hole 50 to the inside of the junction box for various embodiments which require it. In some embodiments, such as an inverter connection, this may be a pushbutton switch. Further embodiments may use the access hole to permit visual access to a status light. Where such access is not desired, and/or where electrical codes may require it, this access hole 50 may be closed using a plug similar to a knockout plug (not shown). Further, FIG. 3B illustrates a removable section 52 which can be readily removed to permit incorporating additional electrical features, such as sensors.

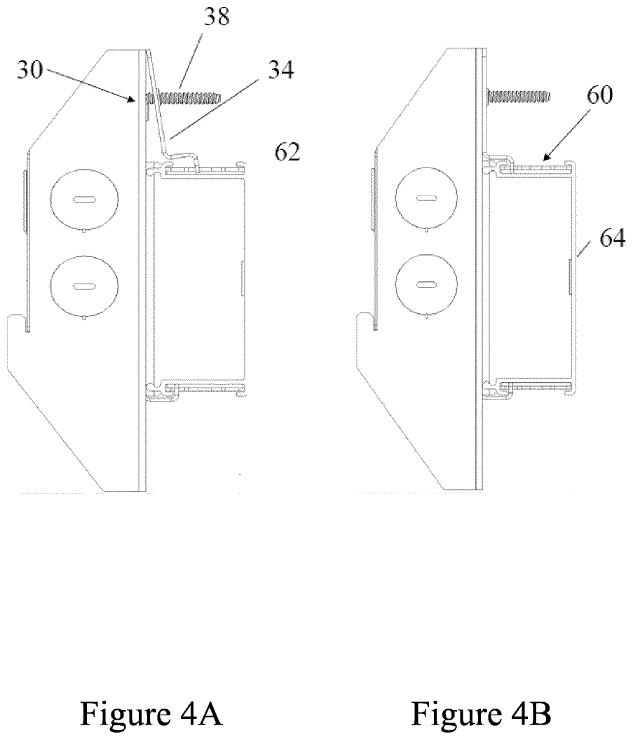

Returning to the action of the clamping flange 34 described above, FIGS. 4A and 4B illustrate the action of the flange 34 as the clamping flange screws 38 are tightened. In particular, FIG. 4A illustrates the clamping flange 34 almost resting against the top edge 62 of the inverter 60 before the clamping flange screws 38 are tightened. As those screws are tightened, the positioning and shape of the clamping flange 34 causes the V-shaped teeth on its lower edge 36 to dig into the top edge 62 of the inverter 60—as illustrated in FIG. 4B. The inverter is thus trapped in all degrees of freedom.

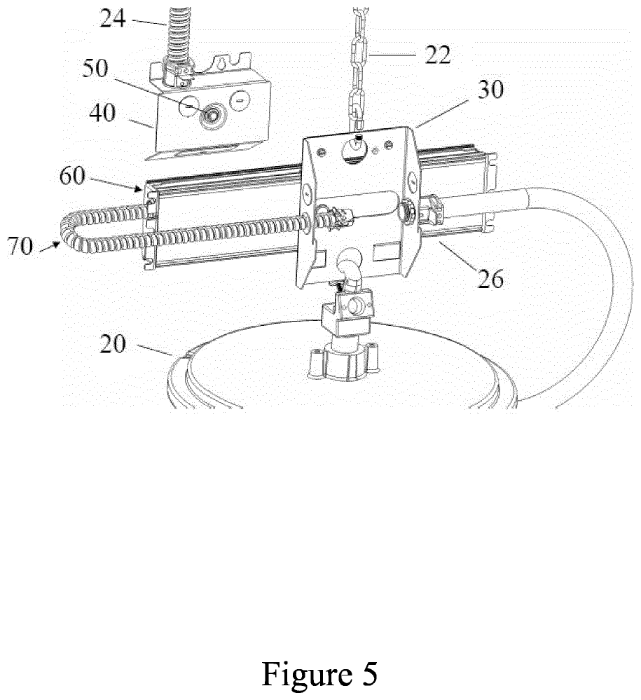

FIG. 5 illustrates components of the junction box in use. The electrical device (e.g. an inverter 60), AC power and light fixture 20 are individually connected to the junction box via cables or conduits. The AC power is supplied to the front section 40 of the junction box by power cable 24. Inverter 60 is connected to the back section 30 of the junction box by conduit 70. Light fixture 20 is connected to the back section 30 of the junction box by conduit 26. Thus, once the front section 40 is positioned proximate the back section 30, the electrical connections of the various wires in the conduits can be a completed. The front section 40 can then be secured to the back section 30 of the junction box as discussed above with respect to FIG. 3B. Consequently, all wiring connections are thus secured inside the enclosed space of the junction box 10.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components, the terms used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”.

The present invention has been described with reference to the preferred embodiments. However, modifications and alterations will occur to others upon reading and understanding the preceding detailed description. It is intended that the present invention be construed as including all such modifications and alterations. It is only the claims, including all equivalents that are intended to define the scope of the present invention.

In the claims references in parentheses refer to reference signs in drawings of exemplifying embodiments or to formulas of embodiments, thus increasing the intelligibility of the claim. These references shall not be construed as limiting the claim.

1. A junction box for use inline with a suspended light fixture, the junction box enabling addition of an electrical device, the junction box comprising:
a back section comprising:
an upper hole for attachment to a building structure,
a bottom hole for suspension of said light fixture,
at least one knockout plug for enabling electrical connections, and
support flanges on an external side of the back section for temporarily and externally suspending the electrical device to the back section;
a clamping flange for fixedly securing the electrical device to the external side of back section;
front section when coupled to the back section forms junction box to house the electrical connections; and
wherein AC power, the electrical device, and the light fixture, are individually electrically connectable to the junction box via conduits.

2. The junction box of claim 1 wherein the light fixture is a light emitting diode (LED) fixture.

3. The junction box of claim 2 wherein the electrical device being secured is an inverter, the inverter having a bottom edge which is capable of resting on said support flanges and an opposite top edge.

4. The junction box of claim 3 wherein the clamping flange comprises V-shaped teeth capable of engaging the top edge of the inverter.

5. The junction box of claim 1 wherein the back section further comprises tabs for receiving and temporarily securing the front section to the back section.

6. The junction box of claim 1 wherein the front section comprises a through hole, and wherein the back section further comprises a threaded hole for receiving a securing screw, which securing screw when passed through the through hole and tightened into the threaded hole secures the front section to the back section.

7. The junction box of claim 6 wherein the front section comprises an access hole which permits visual access to the interior of the junction box.

8. The junction box of claim 7 wherein said access hole is covered by a removable plug when not in use.

9. The junction box of claim 6 wherein the front section comprises an access hole which permits access to an inverter switch.

10. The junction box of claim 6 wherein the front section comprises a removable access piece which permits additional electrical features to be incorporated in the interior of the junction box.

11. A method of incorporating an inverter in-line with a suspended LED light fixture using the junction box of claim 1, the method comprising:
using the upper hole to attach the back section to a building structure,
using the bottom hole to suspend the light fixture from the junction box,
securing the inverter to the back section,
removing any necessary knockout plugs and routing of light fixture conduit and inverter conduit to the back section, and
removing any necessary knockout plugs and routing of power cable to the front section.

12. The method of claim 11 further comprising:
temporarily positioning the front section and the back section in proximity to each other to permit making the necessary electrical connections between the power cable, the inverter, and the light fixture,
securing the front section to the back section.
